(19) United States
(12) Patent Application Publication
(10) Pub. No.: US 2006/0015540 A1
(43) Pub. Date: Jan. 19, 2006

(54) Content system, content terminal, reference server, content program, and reference program

(75) Inventors: Takashi Takeda, Kanagawa (JP); Akio Koresawa, Kanagawa (JP); Ryu Sukigara, Kanagawa (JP); Yoichi Ohshige, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 11/175,269

(22) Filed: Jul. 7, 2005

(30) Foreign Application Priority Data
Jul. 14, 2004 (JP) 2004-206945

(51) Int. Cl. G06F 17/30

(52) U.S. Cl. 707/201

(57) ABSTRACT

A content terminal is storing management information that indicates the management status of a content. When some change occurs in the management status of the content, the content terminal updates the management information in its storage to meet the change, and notifies the updated details to a reference server. The reference server is the one storing reference information, which carries the same types of details as the management information. When receiving the updated details of the management information from the content terminal, the reference server uses thus notified updated details to update the reference information of a user. Because the management information and the reference information are correlated with each other, the user can see the details of the management information in the reference site using the content terminal. In such a manner, the user can refer to and update the details of the management information without directly accessing the control terminal.

### CROSS REFERENCES TO RELATED APPLICATIONS

The present invention contains subject matter related to Japanese Patent Application JP 2004-206945 filed in the Japanese Patent Office on Jul. 14, 2004, the entire contents of which being incorporated herein by reference.

### BACKGROUND OF THE INVENTION

1. Field of the Invention

The present invention relates to content systems, content terminals, reference servers, content programs, and reference programs and, more specifically, to a system for using a reference server for reference of the management status of a content in a content terminal.

2. Description of the Related Art

The development of communications networks exemplified by the Internet has led to services of, over the networks, content transmission from content servers to content terminals.

With such services, contents become available for users by download or streaming distribution from the content servers to the content terminals, for example.

The content terminals are in charge of generating and updating management information about contents that become available through purchase, for example, and managing the contents using the resulting management information.

The users refer to the management information to see the status of contents available in the content terminals, e.g., list of purchased contents, download progress, or requirements for license purchase.

Such content services over the networks are found in Patent Document 1 (JP-A-2003-216828), describing about “content sales system and method”.

In Patent Document 1, a content is transmitted to member users, and a license is issued to the users to put the content to use. After user authentication using the license, the content becomes available for the users.

### SUMMARY OF THE INVENTION

The problem here is that the management information in the content terminals is not available for reference from external terminals.

This thus does not allow the users to check the content status away from home using their portable terminals, e.g., what contents have been purchased, license acquisition status, or content booking status. This may disadvantageously cause the users to mistakenly purchase the same content twice, for example.

Therefore, it is considered desirable to eliminate the need for directly accessing the content terminals to refer to and update the details of the management information.

According to an embodiment of the present invention, there is provided a content system that includes a content terminal for receiving a content from a content server for use, and a reference server for referring to the management status of the content in the content terminal. In the content system, the content terminal stores management information indicating the management status of the content for use. The reference server stores reference information for reference use of the details of the management information, and establishes a synchronization of details between the reference information in storage and the management information through communications with the content terminal, thereby allowing terminals to view the details of the reference information as a result of synchronization of details (First Configuration).

According to the embodiment of the present invention, there is also provided a content terminal that includes: a content section for receiving a content from a content server for use; a management information storage section for storing management information indicating the management status of the content for use in the content section; a management information update section for updating the stored management information when some change occurs in the management status of the content; and an updated details transmission section for transmitting the updated details to a reference server that is in charge of managing reference information for reference use of the details of the management information (Second Configuration).

In the second configuration, alternatively, the content terminal may include an appendix information reception section for receiving, from an appendix information provision server, appendix information coming together with the content provided by the content server, and a management information generation section for generating the management information using the received appendix information and the management status of the content. With such a configuration, the management information storage section may store the generated management information (Third Configuration).

In the third configuration, alternatively, the content terminal may include: an operation command reception section for receiving, from the reference server, an operation command received by the reference server from a terminal for the content referred to by the reference information; an operation section for executing an operation to the content by following the received operation command; and an update section for updating the management information of the content stored by the management information storage section using the details of the operation (Fourth Configuration).

In the third configuration, still alternatively, when the management information of the content being an operation target of the operation command is not found in the management information storage section, the content terminal may include an additional storage section for additionally storing the management information of the content into the management information storage section (Fifth Configuration).

According to the embodiment of the present invention, there is also provided a reference server that includes: a reference information storage section for storing reference information for reference use of the details of management information that is used by a content terminal for managing a content for use in the content terminal; an updated details reception section for receiving, from the content terminal, the updated details derived by the content terminal updating the details of the management information; and a reference information update section for updating the stored reference information using the received updated details (Sixth Configuration).

In the sixth configuration, alternatively, the reference server may include a check request accept section for accepting a request from a terminal for checking the stored reference information, and a reference details transmission section for transmitting, to the terminal, the details of the reference information in accordance with the accepted check request (Seventh Configuration).

In the sixth configuration, still alternatively, the reference server may include an operation command accept section for accepting, from the terminal, an operation command for the content referred to by the reference information, and an operation command transmission section for transmitting the accepted operation command to the content terminal. In the reference server, the reference information update section may update the stored reference information using the accepted operation command (Eighth Configuration).

In the eighth configuration, alternatively, the operation command accept section may accept, from the terminal, an operation command for the content not referred to by the reference information. The operation command transmission section may transmit, to the content terminal, the operation command for the content not referred to by the accepted reference information. The reference information update section may make the reference information storage means additionally store the reference information of the content not referred to by the reference information (Ninth Configuration).

According to the embodiment of the present invention, there is also provided a content program embodied on a computer, including the program codes operable to: receive a content from a content server for use; store management information indicating the management status of the content for use with the content program code; update the stored management information when some change occurs in the management status of the content; and transmit the updated details to a reference server in charge of managing reference information for reference use of the details of the management information (Tenth Configuration).

In the tenth configuration, alternatively, the content program may be embodied on a computer, including the program codes operable to receive, from an appendix information provision server, appendix information coming together with the content provided by the content server, and generate the management information using the received appendix information and the management status of the content. The management information storage program code may be configured to store the generated management information (Eleventh Configuration).

In the eleventh configuration, alternatively, the content program embodied on a computer may include the program codes operable to: receive, from the reference server, an operation command received by the reference server from a terminal for the content referred to by the reference information; execute an operation to the content by following the received operation command; and update the management information of the content stored with the management information storage program code using the details of the operation (Twelfth Configuration).

In the eleventh configuration, still alternatively, the content program may include the program code operable to make the management information storage program code additionally store the management information of the content being an operation target of the operation command when the management information of the content is not stored with the management information storage program code (Thirteenth Configuration).

According to the embodiment of the present invention, there is also provided a reference program that includes the program codes operable to: store reference information for reference use of the details of management information that is used by a content terminal for managing a content for use in the content terminal; receive, from the content terminal, the updated details derived by the content terminal updating the details of the management information; and update the stored reference information using the received updated details (Fourteenth Configuration).

In the fourteenth configuration, alternatively, the reference program may include the program codes operable to accept a request from a terminal for checking the stored reference information, and transmit, to the terminal, the details of the reference information in accordance with the accepted check request (Fifteenth Configuration).

In the fourteenth configuration, still alternatively, the reference program may be embodied on a computer, including the program codes operable to accept, from the terminal, an operation command for the content referred to by the reference information, and transmit the accepted operation command to the content terminal. The reference information update program code may be configured to update the stored reference information using the accepted operation command (Sixteenth Configuration).

In the sixteenth configuration, alternatively, the operation command accept program code may accept, from the terminal, an operation command for the content not referred to by the reference information. The operation command transmission program code may transmit, to the content terminal, the operation command for the content not referred to by the accepted reference information. The reference information update program code may make the reference information storage program code additionally store the reference information of the content not referred to by the reference information (Seventeenth Configuration).

According to an embodiment of the present invention, it is possible to refer and update the details of the management information which is under management of the content terminal without a direct access to the content terminal.

### BRIEF DESCRIPTION OF THE DRAWINGS

FIG. 1 is a block diagram showing an exemplary configuration of a content system;

FIGS. 2A and 2B are both a block diagram schematically showing the function configuration of a content terminal and a reference server;

FIG. 3 is a diagram showing an exemplary logical configuration of management information;

FIG. 4 is a diagram showing an exemplary logical configuration of reference information;

FIG. 5 is a diagram showing an exemplary reference screen;

FIG. 6 is a flowchart for illustrating the procedure of establishing a synchronization of information details between the reference server and the content terminal;

FIG. 7 is a flowchart for illustrating the procedure of accessing a reference site; and

FIG. 8 is a diagram showing an exemplary hardware configuration of the content terminal.

### BEST MODE FOR CARRYING OUT THE INVENTION

### Summary of Embodiment

A content terminal is storing management information, which indicates the management status of contents available therein, e.g., content meta data, download time, or with or without license.

When the management status of the contents shows some change through operation, e.g., purchasing new contents, deleting purchased contents, or acquiring licenses, the content terminal updates the management information in its storage to meet the change. Thus updated details are notified to a reference server.

The reference server is the one storing reference information, which carries the same types of details as the management information.

The management information and the reference information are correlated to each other with user identification information exemplified by a user ID.

When receiving the updated details of the management information from the content terminal, the reference server accordingly updates the reference information of the identified user using the details.

In this manner, the management information in the content terminal is correlated with the reference information in the reference server.

The reference server has a reference site to make the reference information available for viewing on the network.

Thanks to the synchronization of details established between the management information and the reference information, the users can check the details of the management information with the content terminal by making an access to the reference site for their own reference information.

The management information in the content terminal is available from no other client terminal, but is indirectly available for reference from the reference site.

This allows the users to check the details of the management information away from home using their mobile phones to make an access to the reference site, for example.

The users are thus not to purchase the same content twice, or can check before purchase whether any want-to-purchase contents are already downloaded or not, for example.

Moreover, because the reference server stores the same types of details as the management information, when the content terminal is moved to any other client terminal, license acquisition for a second time becomes easy.

What is more, the reference server can accept operation commands in the reference site, e.g., content booking or purchase, or deletion of downloaded content.

When accepting an operation command in the reference site, the reference server updates the reference information based on the operation command, and forwards the operation command to the content terminal.

After receiving the operation command coming from the reference server, the content terminal accordingly executes an operation to the content such as content deletion or purchase.

If an inconsistency arises between the operation command issued by the users from the content terminal and the operation command from the reference site, the inconsistency is resolved in such a manner as giving a higher priority to the operation command accepted more recent of the two.

### Detailed Description of Embodiment

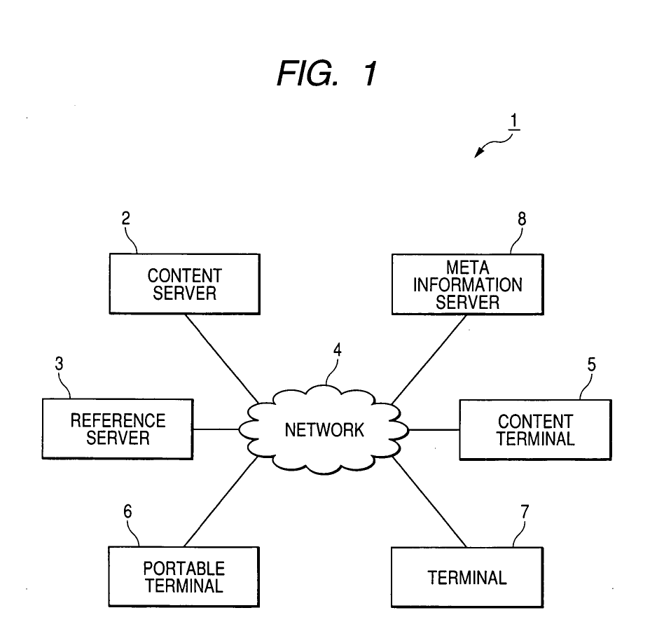

FIG. 1 is a block diagram showing an exemplary configuration of a content system of an embodiment.

A content system 1 is configured by a content server 2, a reference server 3, a content terminal 5, a meta information server 8, a portable terminal 6, and a terminal 7, those of which are connected to one another over a network 4.

The content server 2 provides digital contents to the content terminal 5. The contents provided by the content server 2 are diverse in type, including movie contents, static contents, game contents, music contents, and others.

For content provision, content download or streaming distribution to the content terminal 5 will do.

The meta information server 8 provides meta information of the contents available by the content server 2.

The meta information is appendix information coming together with the contents, including content title, who are appearing, reproduction time, data amount, content overview, and others.

A synchronization of details is established between the contents available by the content server 2 and those from the meta information server 8 by content identification information, for example.

In the present embodiment, the contents and the meta information are described as coming from each different server. This is not restrictive, and the contents and the meta information are to be provided by the same server, e.g., from the content server 2.

Similarly, the reference server. 3 may be configured similarly to the content server 2 or the meta information server 8, or may be configured differently therefrom.

The content terminal 5 is a client terminal using the contents provided by the content server 2, and is configured exemplarily by a personal computer, game machine, set-top box, or any other types of terminals.

The content terminal 5 singly provided in FIG. 1 may be provided plurally.

The content terminal 5 receives meta information from the meta information server 8, and contents from the content server 2. When a license is required to reproduce a specific content, the content terminal 5 receives the license from a license server that is not shown.

In the present embodiment, content reproduction presumably requires a license.

The content terminal 5 stores management information of contents in users' hands.

The management information is updated by the content terminal 5 in such a manner as to reflect the current management status of the contents. The users refer to the resulting updated management information to see the current management status of the contents.

The contents are to be purchased in various manners, and for example, the following manner is an option.

The content terminal 5 first polls the meta information server 8 on a regular basis so as to see whether any new content is available.

When there is any new content, the content terminal 5 downloads the meta information from the meta information server 8 for addition to the management information. The content terminal 5 also downloads the new content from the content server 2.

The user views the downloaded content using the content terminal 5, and if he or she wants to purchase the content, the user purchases the license of the content from the license server for reproduction of the content.

Alternatively, the user may make an access from the content terminal 5 to a sales site set up in the meta information server 8 or others, and download meta information of his or her wanting content.

The content terminal 5 downloads the corresponding content from the content server 2, and then purchases the license thereof from the license server for reproduction of the content.

Exemplified above is a case of changing the timing for meta information download and the timing for content acquisition. This serves well when the content server 2 is presumed to be heavily accessed due to sales of new contents, for example. With this being the case, only the meta information may be forwarded to the content terminal 5 for the meantime so that the transmission time of the contents can be varied.

When the management information is updated, and on a regular basis, for example, the content terminal 5 polls the reference server 3 and forwards the management information to the reference server 3.

Note here that, instead of forwarding the management information in its entirety, only the updated details may be forwarded.

The reference server 3 is in charge of managing the reference information, which is used to refer to the management information that is under the management of the content terminal 5.

The reference information is linked to a user ID, and using this user ID, the reference information is correlated with the management information.

The reference information has the same types of items as the management information, and the reference server 3 communicates with the content terminal 5 to establish a synchronization of details between the reference information and the management information.

The timing for establishing such a synchronization of details is when the content terminal 5 polls the reference server 3, and the reference server 3 updates the reference information in such a manner as to match it to the management information received from the content terminal 5.

The reference server 3 has a reference site that is accessible using the user ID, password, and the like, for viewing of the reference information.

In the reference site, the reference information of the user identified by the user ID and the password is displayed, and operation commands are accepted for content deletion, content booking, or others.

The reference server 3 forwards the operation commands accepted in the reference site at the timing when the content terminal 5 polls.

The portable terminal 6 is a client terminal configured by a mobile phone, a PDA (Personal Digital Assistant), or the like, and can make an access to the reference site of the reference server 3 over the network 4.

The portable terminal 6 singly provided in FIG. 1 may be provided plurally.

The portable terminal 6 includes a display unit exemplified by a liquid crystal display, and can display the details of the reference information coming from the reference server 3.

The portable terminal 6 also includes an input unit for accepting key inputs or others for use to make inputs of URL (Uniform Resource Locators) of the reference site, user ID and password to access the reference site.

Thanks to the synchronization of details established between the reference information and the management information, by accessing the reference site, the users can indirectly check the management information through viewing of the reference information.

In an alternative manner, the users can forward operation commands to the content terminal 5 via the reference site.

The terminal 7 is a client terminal configured by a personal computer or others, for example, and includes a browser for accessing the reference site of the reference server 3.

The terminal 7 singly provided in FIG. 1 may be provided plurally.

Similarly to the portable terminal 6, the terminal 7 can display the details of the reference information, or input the operation commands for the contents in the reference site.

The network 4 is configured by the Internet, for example, and mediates the communications among the components, i.e., the content server 2, the reference server 3, the meta information server 8, the content terminal 5, the portable terminal 6, the terminal 7, and others.

The network 4 is implemented by a telephone circuit, an optical communications network, a radio communications network, a communications network using communications satellites, or the like. The LAN (Local Area Network), WAN (Wide Area Network), or others are also options.

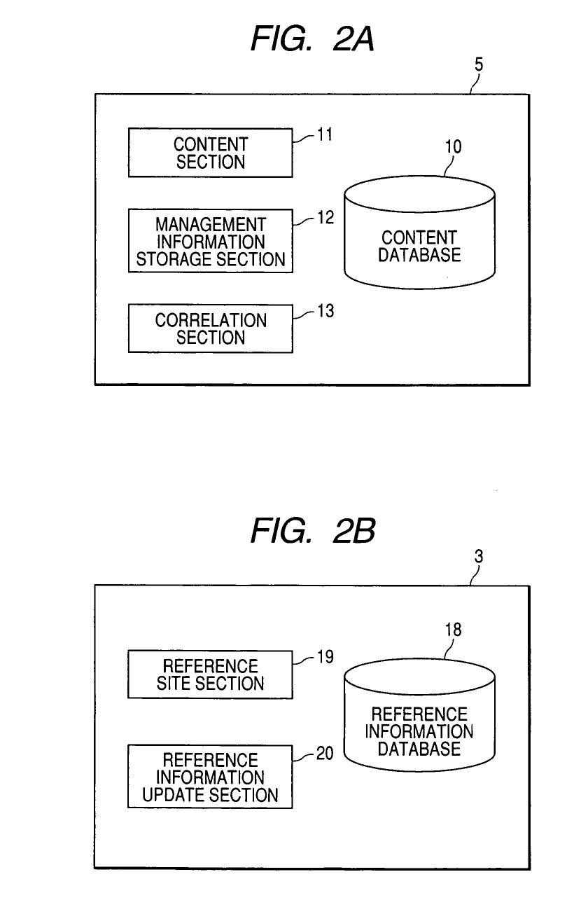

FIG. 2A is a block diagram schematically showing the function configuration of the content terminal 5.

As shown in FIG. 2A, the content terminal 5 includes a content database 10, a content section 11, a management information storage section 12, a synchronization section 13, and others.

The content database 10 stores contents and information needed for reproducing the contents, e.g., the meta information downloaded from the meta information server 8, the contents downloaded from the content server 2, the licenses downloaded from the license server, and the like.

These contents, meta information, and licenses are linked together by the content identification information, for example.

The content section 11 is provided for the users to use the contents, and operates to receive the contents, reproduce the contents, activate the contents, and record and update the management information.

In the below, these operations are described.

1. Content Reception

The content section 11 downloads the meta information from the meta information server 8 for storage into the content database 10, and from the content server 2, downloads the content corresponding to the meta information.

As to any content for streaming distribution, the content section 11 receives the meta information but goes through no content download.

The content is put under the management of the content terminal 5 at the time when the meta information is downloaded, and the content section 11 generates the management information of the content in the management information storage section 12. For generation of the management information, the content section 11 uses the details of the meta information such as the content ID.

The meta information here configures the appendix information coming together with the content, and the content section 11 configures appendix information reception section for receiving the meta information from the meta information server 8 (appendix information provision server), and management information generation section for generating the management information using the meta information.

The content section 11 includes a user interface for content activation and reproduction, and through this user interface, the list of the contents found in the management information storage section 12 can be displayed together with their management status.

The management status includes the content title, downloaded or not, license effective and expiration times and dates (if license has been acquired), booked or not, and the like.

When receiving from the user a command to purchase the license of a specific content in the list, the content section 11 downloads the corresponding license from the licenser server for storage into the content database 10.

After license purchase as such from the license server, the money is withdrawn from the user's bank account so that the purchase payment is made.

2. Content Reproduction

The content section 11 uses the user interface to display a list of contents already through with license acquisition.

The user interface may be configured to display the contents not yet through with license acquisition, or the contents themselves not yet acquired. With this being the case, the users will find it convenient if the acquisition status is displayed both for the licenses or the contents.

The user interface offers a list of reproducible contents for user selection. The user interface also includes an operation section for controlling reproduction of the content, e.g., play button, stop button, rewind button, fast-forward button, and the like. When the user operates this operation section, the content section 11 responsively reproduces or stops the content, for example.

As such, the content section 11 configures content means for receiving the contents from the content server 2 for use.

In a case where the content database 10 carries any specific downloaded content, the content section 11 reads out the content from the content database 10 for reproduction. If this content is subjected to streaming reproduction, the content section 11 is connected to the content server 2 for streaming distribution of the content, and reproduces the content in a sequential manner.

3. Content Operation

In addition to content reproduction, the content section 11 is capable of operating as commanded by the user through the user interface, e.g., content deletion, content booking, new purchase of content, and others. For content deletion, the content, the meta information, the license, and others stored in the content section 11 are deleted therefrom.

For content booking for purchase, the meta information is downloaded in advance, and after the content is put on the market, the content is downloaded or streaming distributed.

For new purchase of content, the meta information and the content are both downloaded, and the license is also purchased.

For content operation, executed are commands coming through the user interface, and commands provided by the reference server 3, which will be described later.

In more detail, the reference server 3 is capable of receiving commands from the portable terminal 6 or the terminal 7 in the reference site for operating the content, and when the content terminal 5 polls the reference server 3, those operation commands are forwarded from the reference server 3 to the content terminal 5.

If an inconsistency arises between the user's operation command issued in the reference site for content deletion, and another in the user interface for content booking, for example, the content section 11 follows the command issued more recent of the two.

As such, when an inconsistency is observed for the operation commands issued in the reference site and the user interface, the content section 11 is capable of determining which comes first, i.e., giving a higher priority to the operation command issued more recent of the two.

4. Recording and Update of Management Information

As to the contents in hands, the content section 11 makes the management information storage section 12 store the management information indicating the management status of those contents. When the management status shows some change, the content section 11 updates the management information in accordance with the change details.

After downloading the meta information from the meta information server 8, the content section 11 adds, to the management information storage section 12, the management information of the content corresponding to the meta information. The content is then put under its management.

Therefore, the contents are not always downloaded even if those are under the management of the management information storage section 12.

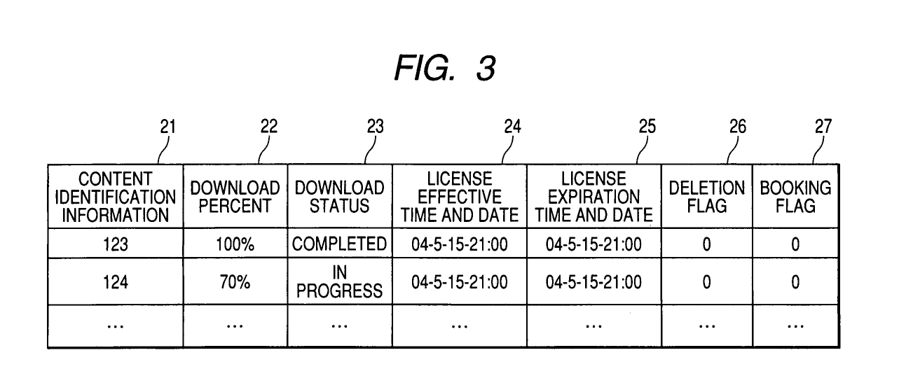

FIG. 3 shows an exemplary logical configuration of the management information. As shown in the drawing, the management information includes items of content identification information 21, download percent 22, download status 23, license effective time and date 24, license expiration time and date 25, deletion flag 26, booking flag 27, and others, those of which are provided on a content basis.

When any new content is put under the management of the content terminal 5, the management information of the content is added.

The content identification information 21 is for the use of content discrimination, and includes a content number, caption, and others.

The download percent 22 represents the download progress of the contents by percent.

Alternatively, the download progress may be represented by an estimated time for download completion, for example.

The download status 23 represents the download progress for the content. When the content is already downloaded, the item shows “completed”, when the content is being downloaded, “in progress”, and when the content is not yet downloaded, “not yet”, for example.

The license effective time and date 24 indicates when and what time the license becomes effective.

The license expiration time and date 25 indicates when and what time the acquired license is to be expired. After the time and date set to the license expiration time and date 25, there needs to acquire a new license.

The license varies in type as such, and some are effective for a fixed period of time, and some are no-time-limit after the purchase.

When no license is purchased, the license effective time and date 24 and the license expiration time and date 25 are both left blank.

The deletion flag 26 indicates whether the downloaded content has been deleted or not. When the content is not deleted, the item shows “0”, and when the content has been deleted, indicated is “1”.

The user may delete the downloaded content(s) to increase the capacity of the storage unit or to eliminate any unnecessary content. The deletion flag 26 thus helps the users to see whether the content has been deleted or not.

The booking flag 27 indicates whether the content is booked for purchase or not. When the content is not yet booked, the item shows “0”, and when the content is already booked, indicated is “1”.

The user can book any soon-to-be-available content before its release date. The booking flag 27 thus helps the users to see whether the content is booked or not.

Referring back to FIGS. 2A and 2B, when the management status of the contents shows some change, the content section 11 updates the management information stored in the management information storage section 12 in accordance with the change details. Such a change occurs when any new content is put under the management of the content section 11, when the content download is started, when any new license is purchased, when any content is deleted, when any content is booked for purchase, and the like.

Here, the management information storage section 12 configures management information storage means, and the content section 11 configures management information update means for updating the management information when the management status of the contents shows some change.

Described next is the synchronization section 13.

The synchronization section 13 is connected to the reference server 3 to cooperate together therewith for operation, and establishes a synchronization of details between the management information stored in the management information storage section 12 and the reference information stored in the reference server 3.

When the content section 11 updates the management information stored in the management information storage section 12, the synchronization section 13 is connected to the reference server 3 for polling at a predetermined time, e.g., every hour. The synchronization section 13 then goes through a process together with the reference server 3 to establish a synchronization of details between the management information and the reference information.

After connected to the reference server 3, the synchronization section 13 forwards the user ID stored in the content section 11 to the reference server 3 for user identification therein.

The reference server 3 uses the user ID to check the reference information of the identified user, and when there is any operation command accepted in the reference site, forwards the command to the content terminal 5. The synchronization section 13 accepts the operation command.

After receiving the operation command from the reference server 3, the content section 11 executes the commanded operation details. The content section 11 then updates the management information stored in the management information storage section 12 so that the management information becomes the latest.

The synchronization section 13 forwards the latest management information to the reference server 3. Instead of forwarding the management information in its entirety to the reference server 3, the synchronization section 13 may forward only any change details, i.e., a difference observed to the management information after connected to the reference server 3.

As such, the synchronization section 13 configures updated detail transmission means for transmitting the updated details of the management information to the reference server 3.

The synchronization section 13 configures operation command reception means for receiving the operation commands from the reference server 3, and the content section 11 configures operation means for activating the contents in response to the received operation commands. The synchronization section 13 configures update means for updating the management information with the details operated by the operation means.

For a case where a command comes to the reference server 3 for addition of a content not yet managed by the management information of the content terminal 5, e.g., purchase of new content, the content section 11 is provided with additional storage section for making the management information storage section 12 additionally store the management information about such a content.

FIG. 2B is a block diagram schematically showing the function configuration of the reference server 3.

As shown in FIG. 2B, the reference server 3 is configured by a reference information database 18, a reference information update section 20, a reference site section 19, and others.

The reference information database 18, stores the reference information, which is used to refer to the details of the management information that is under the management of the content terminal 5 for the respective users. The reference information database 18 configures reference information storage means.

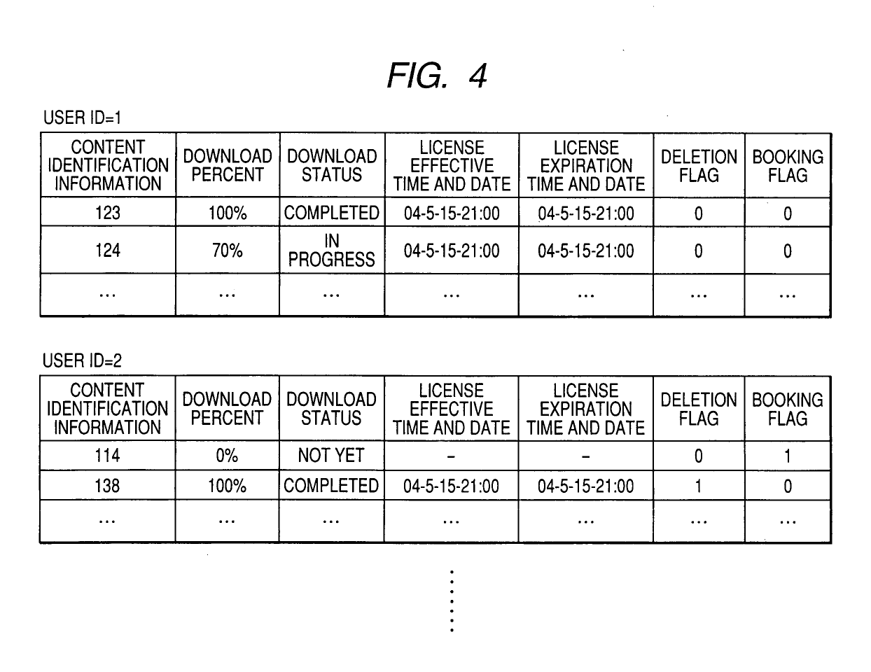

FIG. 4 shows the logical configuration of the reference information.

As shown in FIG. 4, the reference information is provided for every user using the user ID. The reference information of the respective users includes the same items as those in the management information shown in FIG. 3.

Referring back to FIG. 2B, the reference site section 19 offers a reference site to make the reference information available for viewing on the network 4.

The reference site section 19 accepts accesses from the portable terminal 6 and the terminal 7 (hereinafter, the portable terminal 6 will be mainly described) by a given URL or others, and offers various screens.

After accessed by the portable terminal 6, the reference site section 19 asks the user to forward his or her user ID and password. Using thus provided user ID and password, the reference site section 19 authenticates and identifies the user.

After user authentication, the reference site section 19 searches the reference information database 18 for the user's reference information.

Using thus found reference information, the reference site section 19 generates reference screen data for transmission to the portable terminal 6.

The portable terminal 6 uses the resulting reference screen data to generate a reference screen for display on a display unit exemplified by a display.

Here, the reference site section 19 configures both confirmation request accept means, and reference details transmission means. The confirmation request accept means accepts a request from the portable terminal 6 or others for checking the reference information, and the reference details transmission means forwards the details of the reference information to the portable terminal 6 or others.

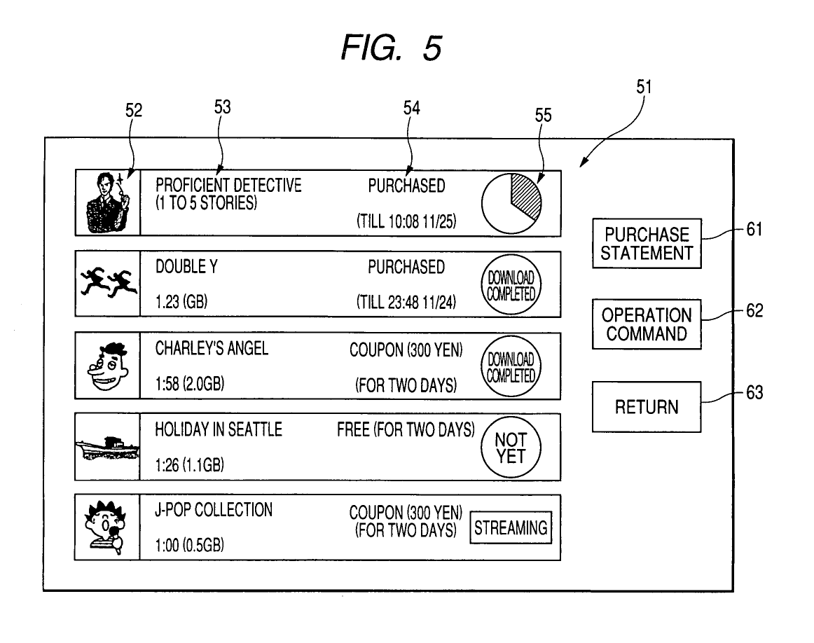

FIG. 5 shows an exemplary reference screen.

As shown in FIG. 5, the reference screen includes a content list section 51, a purchase statement button 61, an operation command button 62, a return button 63, and others.

The content list section 51 displays a list of contents found in the reference information, except for the deleted content(s) showing the deletion flag of “1”.

The items listed by the content list section 51 include a thumbnail 52, a title 53, a purchase status 54, a download status 55, and the like.

The thumbnail 52 shows an image with which the content details are visualized. The reference server 3 stores image data in a corresponding manner to the content identification information, and the image to be displayed to the thumbnail 52 is configured by this image data.

The title 53 displays the title of the content. The reference server 3 stores title data in a corresponding manner to the content identification information, and the title indicated by the title 53 is configured by this title data.

The purchase status 54 indicates whether the license of the content is purchased or not, and the effective and expiration times and dates of the license. When the license is already purchased, the item indicates “purchased”. The content system 1 offers a coupon to the users for use to purchase the content.

Although not described above, the management information of FIG. 3 and the reference information of FIG. 4 can include information about whether the user uses a coupon for content purchase, or about the remaining amount of the coupon after content purchase, for example.

If the user uses a coupon to buy a specific content, the purchase status 54 provides such an indication.

The download status 55 indicates whether the content has been downloaded or not, and if the content is being downloaded, the download progress or others are indicated.

Such display is made using information such as the download percent or download status of the reference information.

Although not described above, as to the management information of FIG. 3 and the reference information of FIG. 4, when the content is subjected to streaming distribution, such an indication is made.

If this content is the one for streaming reproduction, the download status 55 makes such an indication.

The purchase statement button 61 is used to jump to the screen displaying the user's purchase statement.

Although not shown in FIG. 2B, the reference server 3 includes data about the user's purchase statement, and when the user selects the purchase statement button 61, the reference server 3 responsively forwards the data of purchase statement to the portable terminal 6.

The operation command button 62 is used to jump to the screen for content operation. When the user selects the operation command button 62, the reference server 3 forwards the data of operation command to the portable terminal 6. The portable terminal 6 then uses thus provided data for display of the screen for operation command.

On the screen for operation command, the user can issue predetermined commands of content deletion, content booking, or others for the contents displayed on the reference screen. The user can also issue a command to purchase any new content.

The operation details made on the operation command screen are forwarded to the reference server 3.

The return button 63 is used to jump to the initial screen of the reference site.

Referring back to FIG. 2B, the reference site section 19 notifies the portable terminal 6 and the terminal 7 of the details of the reference information as such, and also accepts the operation commands from the portable terminal 6 and the terminal 7.

When accepting an operation command from the user, the reference site section 19 updates the reference information stored in the reference information database 18 in such a manner as to reflect the operation command.

As such, the reference site section 19 configures operation command accept means for accepting the operation commands from the portable terminal 6 or others.

The reference site section 19 also configures reference information update means for updating the reference information using the accepted operation commands.

When accepting a command for adding any content not found in the reference information, i.e., a command for purchasing any new content, the reference site section 19 additionally stores the command to the reference information for transmission to the content terminal 5.

If the user issues a command for deleting any specific content, for example, the deletion flag for the content is set to “1”. If the user issues a command for booking any specific content, the booking flag for the content is set to “1”, and if with a command for purchasing any specific new content, the information indicating as such is added.

The reference information update section 20 accepts a polling connection from the synchronization section 13 so as to establish a synchronization of details between the reference information and the management information.

When accepting the connection from the synchronization section 13, the reference information update section 20 forwards the user's operation command to the synchronization section 13. More in detail, forwarded to the synchronization section 13 may be the user's reference information, or only the operation command.

As such, the reference information update section 20 configures operation command transmission means for forwarding the operation commands accepted from the portable terminal 6 or others to the content terminal 5.

The reference information update section 20 receives the latest management information from the synchronization section 13, and updates the reference information in such a manner as to match it to the received management information. As such, the reference information update section 20 configures reference information update means.

In the above, the management information of FIG. 3 and the reference information of FIG. 4 have the same items. This is not restrictive, and the reference information does not necessarily carry all the items of the management information. The items of the reference information may be set as those for notification to the user, or for, reception of the operation commands.

With this being the case, the reference information update section 20 refers to the management information for every item of the reference information, and updates the reference information to be the latest.

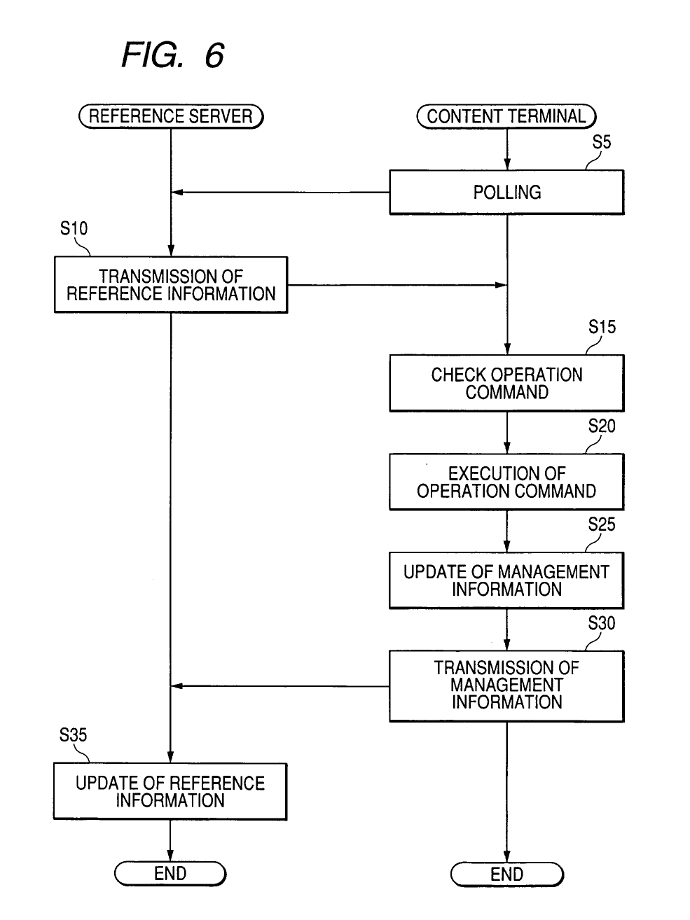

By referring to the flowchart of FIG. 6, described next is the procedure of establishing a synchronization of information details between the reference server 3 and the content terminal 5.

First of all, the content terminal 5 is connected to the reference server 3 to start polling (step 5).

At this time, the content terminal 5 forwards a user ID to the reference server 3.

The reference server 3 receives the user ID from the content terminal 5. The reference server 3 then searches the reference information database 18 for the reference information corresponding to the user ID for transmission to the content terminal 5 (step 10).

The content terminal 5 receives the reference information from the reference server 3 for use to check whether there is any operation command issued by the user (step 15).

In step 15, for example, a comparison is made between the reference information received from the reference server 3, and the management information stored in the content terminal 5 for any possible item for operation commands. Here, the items possible for operation commands are predetermined such as content deletion, content booking, or others.

When some disparity is observed for a specific item, it is determined that the user has issued an operation command thereto.

There may be a case where some inconsistency arises between the operation command found in the reference information and that in the management information. Accordingly, the content terminal 5 compares between the update time and date for the reference information and that for the management information so as to adopt the operation command that is more recent of the two.

Alternatively, in any other manner, the operation command issued in the content terminal 5 and the operation command issued in the reference server 3 may be assigned with priorities.

In this example., presumably, a user's operation command is found in the reference information, and this command is adopted.

The content terminal 5 then executes the operation command found in the reference information, and accordingly goes through content deletion, content booking, or the like (step 20).

The content terminal 5 then updates the management information in such a manner as to reflect the management status showing some change due to operation (step 25), and forwards the resulting management information to the reference server 3 (step 30).

The reference server 3 receives the management information from the content terminal 5, and updates the user's reference information to match it to the management information (step 35).

Although not shown, after receiving a notification from the reference server 3 telling that the reference information is completely updated, the content terminal 5 cuts off the connection with the reference server 3.

As such, the reference server 3 and the content terminal 5 can establish a synchronization of details between the management information and the reference information.

In step 15, when no user's operation command is found in the reference information, the management information in storage is forwarded to the reference server 3 as it is (step 30) without executing the operation command (step 20) or updating the management information (step 25).

In the above, the reference server 3 forwards the reference information to the content terminal 5, and the content terminal 5 forwards the management information to the reference server 3. This is not restrictive, and instead of forwarding entirely the reference information and the management information, only a difference observed from the last polling to the current polling may be forwarded.

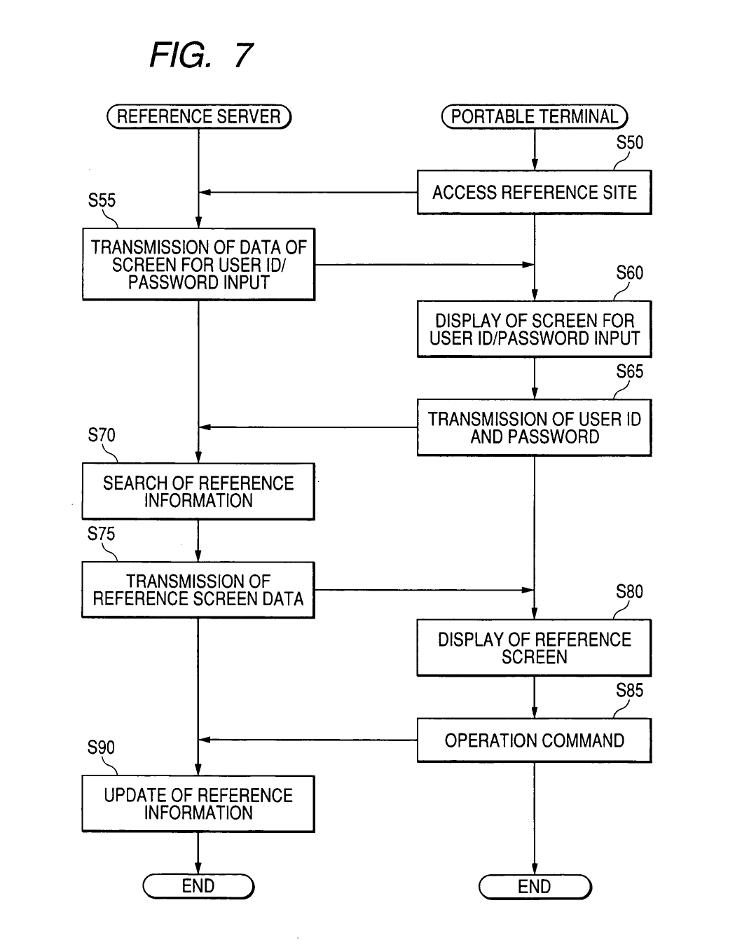

By referring to the flowchart of FIG. 7, described next is the user's procedure of making an access to the reference site from the portable terminal 6 (or the terminal 7).

First of all, the user establishes a connection with the reference server 3 by making an input of URL of the reference site from the portable terminal 6, for example (step 50).

After accepting the access in the reference site, the reference server 3 forwards data of screen for inputting user ID and password to the portable terminal 6 (step 55).

The portable terminal 6 receives the screen data from the reference server 3 for use to display a screen for inputting the user ID and the password (step 60).

While looking at this screen, the user operates the portable terminal 6 to input his or her user ID and password for transmission to the reference server 3 (step 65).

After receiving the user ID and the password from the portable terminal 6, the reference server 3 performs user authentication by comparing those with the user ID and the password in storage.

If the user is identified by the user authentication as such, the reference server 3 then searches the reference information database 18 for the user's reference information (step 70). The reference server 3 uses thus found reference information to generate reference screen data, and forwards the data to the portable terminal 6 (step 75).

The portable terminal 6 receives the reference screen data from the reference server 3 for use to display the reference screen (step 80).

Thanks to the synchronization of details established between the reference information and the management information, the user can check the details of the management information in the content terminal 5 by looking at the reference screen.

When the user wants to issue an operation command such as content deletion, he or she jumps to the content operation screen for input of the operation command for the content. In this example, presumably, the user inputs an operation command, and the portable terminal 6 forwards the user-input operation command to the reference server 3 (step 85).

Using the operation command provided by the portable terminal 6, the reference server 3 updates the user's reference information (step 90).

Although not shown, the reference information 3 notifies the portable terminal 6 that the operation command is entered, and the portable terminal 6 cuts off the connection with the reference server 3.

As such, using the portable terminal 6, the user can check the management status of his/her content(s) in the content terminal 5, and issues operation commands to the content(s).

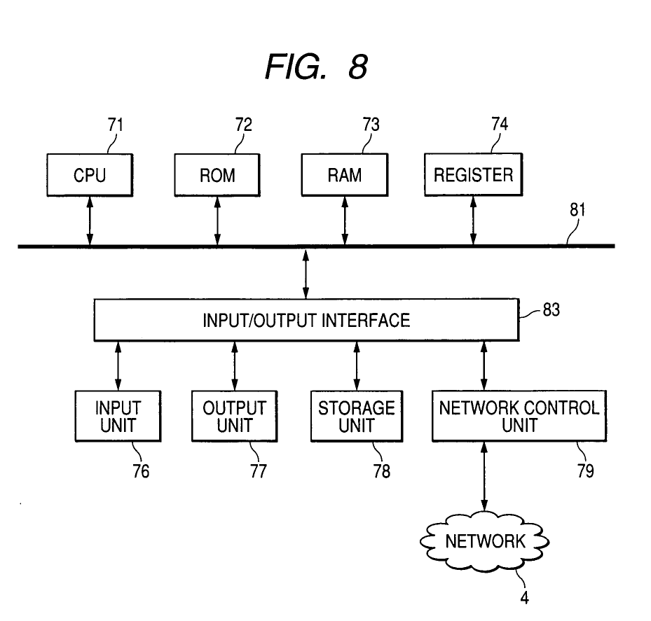

By referring to FIG. 8, described next is the hardware configuration of the content terminal 5.

In the content terminal 5, a connection is established via a bus line 81 among a CPU (Central Processing Unit) 71, ROM (Read Only Memory) 72, RAM (Random Access Memory) 73, a register 74, and an input/output interface 83.

The content terminal 5 is configured by a personal computer, a game machine, or set-top box, for example.

The CPU 71 is a central processing unit for executing various processes by following programs stored in the ROM 72, the RAM 73, a storage unit 78, and others.

The CPU 71 serves to establish a synchronization of details between the management information and the reference information through communications with the reference server 3, or updates the management information by keeping track of the management status of the contents.

The CPU 71 also communicates with the content server 2, the meta information server 8, the license server, and others for receiving the contents, the meta information, and the licenses, and reproduces the contents based on the license.

The ROM 72 is Read-Only Memory, storing any basic programs and parameters needed to function the content terminal 5.

The RAM 73 is Random-Access Memory that is data writable and erasable thereto/therefrom. The RAM 73 serves as working memory when the CPU 71 goes through a synchronization process between the management information and the reference information, or goes through content reproduction.

The register 74 is memory for temporarily storing data for the CPU 71 to execute information processing at high speed.

The input/output interface 83 mediates inputs and outputs among the peripheral equipment including an input unit 76, an output unit 77, the storage unit 78, a network control unit 79, and others.

The input unit 76 is configured by an input device such as keyboard, mouse, or joy stick, and the user uses such a device for information input to the content terminal 5.

With such a configuration, the management information becomes available for viewing, operation commands are issued for contents, or the contents are reproduced.

The output unit 77 is configured by an output device such as display, speaker, or printer, and the contents become available by the user recognizing information coming from such a device.

For example, for reproduction of book contents, static contents, dynamic contents, and others, a display shows texts, still images, and moving images, and those can be output from a printer. For reproduction of music contents, a speaker outputs music.

The storage unit 78 is of large capacity configured by a hard disk drive, for example, and is capable of data reading and writing by the CPU 71.

In addition to the hard disk, the storage unit 78 may also be configured by any other types of storage medium including magneto-optical disk, magnetic disk, semiconductor storage device or others, and a storage medium drive for driving the storage medium.

The storage unit 78 stores an OS (operating system), a communications program, a content program, the content database 10, and others. Here, the OS is for implementing such basic functions as file input/output process in the content terminal 5. The communications program is for carrying out communications with the reference sever 3 and any other servers, and the content program is for using the contents.

By the CPU 71 executing the content program, configured are the content section 11, the management information storage section 12, the synchronization section 13, and others.

The network control unit 79 is configured by a communications control device exemplified by a modem. The network control unit 79 establishes a connection between the content terminal 5 and the network 4 to exercise control over the communications via the network 4.

Although not shown, the bus line 81 may be connected with a storage medium drive detachable with a storage medium such as semiconductor memory, magneto-optical disk, or magnetic disk, and the CPU 71 may perform data reading and writing to/from the storage medium via the storage medium drive.

Through such a storage medium, it is possible to provide the content terminal 5 with the contents, the meta information, the licenses, or others.

The configuration of the content terminal 5 is described above, and the hardware configuration of the components, i.e., the reference server 3, the content server 2, the meta information server 8, the license server, the portable terminal 6, the terminal 7, and others, is basically similar to the content terminal 5.

By the present embodiment described above, the following effects can be successfully derived.

1. By making an access to a reference site of the reference server 3, users can see the management status of their contents under the management of the content terminal 5.

2. Through communications between the reference server 3 and the content terminal 5, a synchronization of details can be established between reference information and management information.

3. By making an access to the reference site, the users can issue operation commands relating to the contents to the content terminal 5.

4. With the management information stored also on the end of the reference server 3, the management information can be easily restored even if the content terminal 5 goes down, or the content terminal 5 is transferred to any other client terminal.

5. As indicating the management status of the users' contents, the reference information can be used for user management by content providers or others.

It should be understood by those skilled in the art that various modifications, combinations, sub-combinations and alterations may occur depending on design requirements and other factors insofar as they are within the scope of the appended claims or the equivalent thereof.

What is claimed is:

1. A content system including a content terminal for receiving a content from a content server for use, and a reference server for referring to a management status of the content in the content terminal, wherein
the content terminal stores management information indicating the management status of the content for use, and
the reference server stores reference information for reference use of details of the management information, establishes a synchronization of details between the stored reference information and the management information through communications with the content terminal, and gives a permission for a terminal to view of details of the reference information as a result of the synchronization of details.

2. A content terminal, comprising:
content means for receiving a content from a content server for use;
management information storage means for storing management information indicating a management status of the content for use in the content means;
management information update means for updating the stored management information when a change occurs in the management status of the content; and
updated details transmission means for transmitting the updated details to the reference server in charge of managing reference information for reference use of details of the management information.

3. The content terminal according to claim 2, comprising:
appendix information reception means for receiving, from an appendix information provision server, appendix information coming together with the content provided by the content server; and
management information generation means for generating management information from the received appendix information and the management status of the content, wherein
the management information storage means stores the generated management information.

4. The content terminal according to claim 3, comprising:
operation command reception means for receiving, from the reference server, an operation command received by the reference server from a terminal for a content referred to by the reference information;
operation means for executing an operation for the content by following the received operation command; and
update means for updating the management information of the content stored by the management information storage means using details of the operation.

5. The content terminal according to claim 3, comprising
additional storage means for making the management information storage means additionally store the management information of the content being an operation target of the operation command when the management information of the content is not stored in the management information storage means.

6. A reference server, comprising:
reference information storage means for storing reference information for reference use of details of management information that is used by a content terminal for managing a content for use in the content terminal;
updated details reception means for receiving, from the content terminal, the updated details derived by the content terminal updating the details of the management information; and
reference information update means for updating the stored reference information using the received updated details.

7. The reference server according to claim 6, comprising:
check request accept means for accepting a request from a terminal for checking the stored reference information; and
reference details transmission means for transmitting, to the terminal, details of the reference information in accordance with the accepted check request.

8. The reference server according to claim 6, comprising:
operation command accept means for accepting, from a terminal, an operation command for a content referred to by the reference information; and
operation command transmission means for transmitting the accepted operation command to the content terminal, wherein
the reference information update means updates the stored reference information using the accepted operation command.

9. The reference server according to claim 8, wherein
the operation command accept means accepts, from the terminal, an operation command for a content not referred to by the reference information,
the operation command transmission means transmits, to the content terminal, the operation command for the content not referred to by the accepted reference information, and
the reference information update means makes the reference information storage means additionally store the reference information of the content not referred to by the accepted reference information.

10. A content program embodied on a computer, comprising the program codes operable to:
receive a content from a content server for use;
store management information indicating a management status of the content for use with the content program code;
update the stored management information when a change occurs in the management status of the content; and
transmit the updated details to a reference server in charge of managing reference information for reference use of details of the management information.

11. The content program embodied on the computer according to claim 10, comprising the program codes operable to:
receive, from an appendix information provision server, appendix information coming together with the content provided by the content server; and
generate the management information using the received appendix information and the management status of the content, wherein
the management information storage program code stores the generated management information.

12. The content program embodied on the computer according to claim 11, comprising the program codes operable to:
receive, from the reference server, an operation command received by the reference server from a terminal for a content referred to by the reference information;
execute an operation for the content by following the received operation command; and
update the management information of the content stored with the management information storage program code using details of the operation.

13. The content program embodied on the computer according to claim 11, comprising the program codes operable to
make the management information storage program code additionally store the management information of the content being an operation target of the operation command when the management information of the content is not stored with the management information storage program code.

14. A reference program, comprising the program codes operable to:
store reference information for reference use of details of management information that is used by a content terminal for managing a content for use in the content terminal;
receive, from the content terminal, the updated details derived by the content terminal updating the details of the management information; and
update the stored reference information using the received updated details.

15. The reference program according to claim 14, comprising the program codes operable to:
accept a request from a terminal for checking the stored reference information; and
transmit, to the terminal, details of the reference information in accordance with the accepted check request.

16. The reference program according to claim 14, comprising the program codes operable to:
accept, from a terminal, an operation command for a content referred to by the reference information; and
transmit the accepted operation command to the content terminal, wherein
the reference information update program code updates the stored reference information using the accepted operation command.

17. The reference program according to claim 16, wherein
the operation command accept program code accepts, from the terminal, an operation command for a content not referred to by the reference information,
the operation command transmission program code transmits, to the content terminal, the operation command for the content not referred to by the accepted reference information, and
the reference information update program code makes the reference information storage program code additionally store the reference information of the content not referred to by the reference information.

18. A content terminal, comprising:
a content section receiving a content from a content server for use;
a management information storage section storing management information indicating a management status of the content for use in the content section;
a management information update section updating the stored management information when a change occurs in the management status of the content; and
an updated details transmission section transmitting the updated details to the reference server in charge of managing reference information for reference use of details of the management information.

19. A reference server, comprising:
a reference information storage section storing reference information for reference use of details of management information that is used by a content terminal for managing a content for use in the content terminal;
an updated details reception section receiving, from the content terminal, the updated details derived by the content terminal updating the details of the management information; and
a reference information update section updating the stored reference information using the received updated details.
